(19) United States
(12) Patent Application Publication
(10) Pub. No.: US 2019/0246331 A1
(43) Pub. Date: Aug. 8, 2019

(54) MANAGEMENT APPARATUS, COMMUNICATION SYSTEM, AND METHOD THEREFOR

(71) Applicant: NEC Corporation, Tokyo (JP)

(72) Inventor: Hiroaki NAKAJIMA, Tokyo (JP)

(73) Assignee: NEC Corporation, Tokyo (JP)

(21) Appl. No.: 16/317,331

(22) PCT Filed: Jul. 11, 2017
(86) PCT No.: PCT/JP2017/025210

§ 371 Date: Jan. 11, 2019

(30) Foreign Application Priority Data
Jul. 14, 2016 (JP) 2016-139306

(51) Int. Cl. H04W 40/02; H04W 24/04; H04W 40/34

(52) U.S. Cl. CPC H04W 40/02; H04W 40/34; H04W 24/04

(57) ABSTRACT

A management apparatus (10) according to the present invention is a management apparatus for a communication system (100) configured to form redundant paths including an active path and a backup path while including a P2P (Point to Point) radio communication apparatus in the redundant paths. Further, the management apparatus (10) includes a communication unit (11) configured to receive a first transmission delay time of the active path and a plurality of second transmission delay times of a plurality of backup path candidates, and a setting unit (12) configured to select a backup path candidate from the plurality of backup path candidates based on differences between the plurality of second transmission delay times and the first transmission delay time, and set the selected backup path candidate as the backup path.

### TECHNICAL FIELD

The present invention relates to a management apparatus and, in particular, a management apparatus for a communication system in which redundant paths including an active path and a backup path are formed. Further, the present invention relates to a method for such a management apparatus, a communication system including a management apparatus, and a method therefor.

### BACKGROUND ART

In recent years, as radiuses of cells of mobile-phone base stations have been becoming shorter, networks in the Radio Access/Aggregation range in which base stations connect to higher-level networks are becoming larger and more complicated. In networks using complex topology such as Ring and Mesh, there are a plurality of paths that connect endpoints. In such networks, it is common to select a path having a wide bandwidth or a path including a small number of transit nodes as an optimum path based on transmission capacities of lines and the number of transit network nodes.

Further, the following method has been known, i.e., a method in which: redundant paths including an active path and a backup path are formed between nodes; signals are transmitted by using only the active path under normal circumstances; and when a failure occurs in the active path, the signal transmission is continued by using the backup path. Patent Literature 1 discloses a technique in which it is automatically determined which of an active path and a backup path has a shorter transmission delay time, and the path having the shorter transmission delay time is automatically selected as an active path.

### CITATION LIST

### Patent Literature

Patent Literature 1: Japanese Unexamined Patent Application Publication No. 2012-205136

### SUMMARY OF INVENTION

### Technical Problem

However, in some of services in which transmission is performed in packet networks, their service quality is affected due to sudden changes in transmission delay times caused by switching between active paths and backup paths. An example of such services is an ACR (Adaptive Clock Recovery) service in TDM (Time Division Multiplexing) PWE (Pseudo Wire Emulation).

In the ACR service, an apparatus on a receiving side is equipped with a filtering function for reproducing a TDM clock frequency on a transmitting side based on intervals between packet arrivals. This filtering function removes packets having large transmission delay fluctuations that occur in the network section. Consequently, in the ACR service, if the transmission delay time suddenly changes due to switching between the active path and the backup path, the filtering function erroneously reacts to the sudden change and thereby removes a packet to be synchronized.

Therefore, when only the technique in which a path having a short transmission delay time is selected as an active path, such as the technique disclosed in Cited Document 1, is used, there are cases in which a packet to be synchronized is removed by the filtering function due to a sudden change in the transmission delay time caused by switching between the active path and the backup path, and hence cannot be received. Accordingly, there has been a problem that it is necessary to perform re-synchronization and/or reset the filtering function and hence the accuracy of the reproduced clock is affected.

The present invention has been made to solve the above-described problem and an object thereof is to provide a management apparatus, a communication system, and a method therefor capable of avoiding a sudden change in a transmission delay time that would otherwise occur when a path is switched.

### Solution to Problem

A management apparatus according to a first aspect of the present invention is a management apparatus for a communication system configured to form redundant paths including an active path and a backup path while including a P2P (Point to Point) radio communication apparatus in the redundant paths, the management apparatus including: a communication unit configured to receive a first transmission delay time of the active path and a plurality of second transmission delay times of a plurality of backup path candidates; and a setting unit configured to select a backup path candidate from the plurality of backup path candidates based on differences between the plurality of second transmission delay times and the first transmission delay time, and set the selected backup path candidate as the backup path.

A communication system according to a second aspect of the present invention is a communication system configured to form redundant paths including an active path and a backup path while including a P2P (Point to Point) radio communication apparatus in the redundant paths, the communication system including: a network node; and a management apparatus, in which the network node includes: a communication unit configured to transmit/receive a packet to/from another network node; a measurement unit configured to measure a first transmission delay time of the active path and a plurality of second transmission delay times of a plurality of backup path candidates by transmitting/receiving the packet; and a monitoring control unit configured to transmit the first transmission delay time and the plurality of second transmission delay times to the management apparatus, and the management apparatus includes: a communication unit configured to receive the first transmission delay time and the plurality of second transmission delay times; and a setting unit configured to select a backup path candidate from the plurality of backup path candidates based on differences between the plurality of second transmission delay times and the first transmission delay time, and set the selected backup path candidate as the backup path.

A method according to a third aspect of the present invention is a method performed in a management apparatus for a communication system configured to form redundant paths including an active path and a backup path while including a P2P (Point to Point) radio communication apparatus in the redundant paths, the method including: receiving a first transmission delay time of the active path and a plurality of second transmission delay times of a plurality of backup path candidates; selecting a backup path candidate from the plurality of backup path candidates based on differences between the plurality of second transmission delay times and the first transmission delay time; and setting the selected backup path candidate as the backup path.

A method according to a fourth aspect of the present invention is a method performed in a communication system configured to form redundant paths including an active path and a backup path while including a P2P (Point to Point) radio communication apparatus in the redundant paths, in which the communication system includes a network node, and a management apparatus, the network node is configured to: transmit/receive a packet to/from another network node; measure a first transmission delay time of the active path and a plurality of second transmission delay times of a plurality of backup path candidates by transmitting/receiving the packet; and transmit the first transmission delay time and the plurality of second transmission delay times to the management apparatus, and the management apparatus is configured to; receive the first transmission delay time and the plurality of second transmission delay times; select a backup path candidate from the plurality of backup path candidates based on differences between the plurality of second transmission delay times and the first transmission delay time; and set the selected backup path candidate as the backup path.

A management apparatus according to a fifth aspect of the present invention is a management apparatus for a communication system including a first path and a plurality of second paths, the management apparatus including: a communication unit configured to receive a transmission delay time in the first path and transmission delay times in the second paths; and a setting unit configured to select a backup path for the first path from the plurality of second paths based on differences between the transmission delay times in the second paths and the transmission delay time in the first path.

### Advantageous Effects of Invention

According to the present invention, it is possible to provide a management apparatus, a communication system, and a method therefor capable of avoiding a sudden change in a transmission delay time that would otherwise occur when a path is switched.

### BRIEF DESCRIPTION OF DRAWINGS

FIG. 1 is a block diagram showing a configuration example of a communication system according to a first embodiment of the present invention;

FIG. 2 is a block diagram showing a configuration example of a management apparatus according to the first embodiment of the present invention;

FIG. 3 is a block diagram showing a configuration example of a network node according to the first embodiment of the present invention;

FIG. 4 is a flowchart showing an operation example of the management apparatus according to the first embodiment of the present invention;

FIG. 5 is a flowchart showing an operation example of a management apparatus according to a second embodiment of the present invention;

FIG. 6 is a diagram for explaining an example of resetting of a backup path according to the second embodiment of the present invention;

FIG. 7 is a graph showing an example of a relation between transitions of a transmission delay time of an active path and resetting of a backup path according to the second embodiment of the present invention;

FIG. 8 is a diagram for explaining an example of resetting of a backup path according to the second embodiment of the present invention;

FIG. 9 is a flowchart showing an operation example of a management apparatus according to a third embodiment of the present invention;

FIG. 10 is a flowchart showing an example of a backup-path resetting operation performed by the management apparatus according to the third embodiment of the present invention; and

FIG. 11 is a flowchart showing another example of a backup-path resetting operation performed by the management apparatus according to the third embodiment of the present invention.

### DESCRIPTION OF EMBODIMENTS

Embodiments according to the present invention will be described hereinafter in detail with reference to the drawings. The same or corresponding elements are denoted by the same symbols throughout the drawings, and duplicated explanations are omitted as necessary for the sake of clarity of the explanations.

### First Embodiment

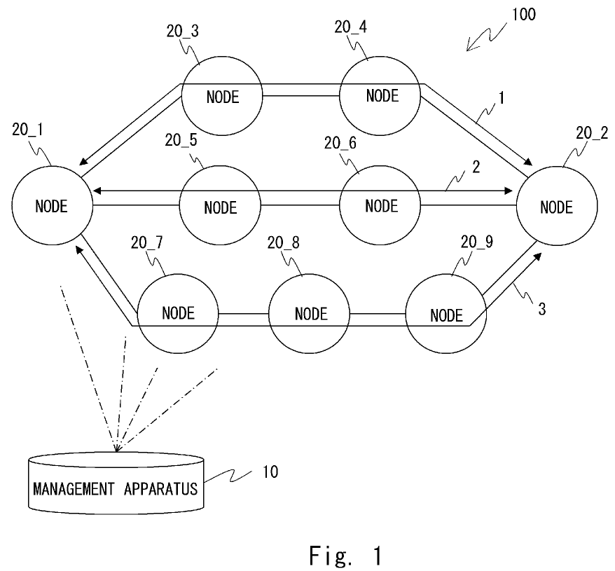

Firstly, a configuration example of a communication system 100 according to a first embodiment of the present invention is described with reference to a block diagram shown in FIG. 1. The communication system 100 according to the first embodiment includes a management apparatus 10 and network nodes 20. In FIG. 1, nine nodes, i.e., network nodes 20_1 to 20_9 are shown as the network nodes 20. Note that the number of network nodes 20 is not limited to nine.

Each of the network nodes 20 is an apparatus that is connected to and communicates with other network nodes 20 through a wired communication path or a wireless communication path. The network node 20 is, for example, a base station, a switch, a router, a gateway, etc.

In the example shown in FIG. 1, a path 1, a path 2, and, a path 3 are formed between the network nodes 20_1 and 20_2. The path 1 is a path including the network nodes 20_3 and 20_4. Further, the path 2 is a path including the network nodes 20_5 and 20_6. Further, the path 3 is a path including the network nodes 20_7, 20_8 and 20_9. The network node 20_1 can communicates with the network node 20_2 through one of the paths 1, 2 and 3.

The management apparatus 10 is connected to each of the network nodes 20 and performs monitoring, controlling, and the like of each network node 20. The management apparatus 10 is, for example, an NMS (Network Management System). Note that the management apparatus 10 is not limited to NMS, and may instead be any kind of apparatus that can perform monitoring, controlling, and the like of each network node 20.

Note that the communication system 100 is a communication system that forms redundant paths including an active path and a backup path while including a P2P (Point to Point) radio communication apparatus in the redundant paths. Specifically, among the network nodes 20_1 to 20_9 shown in FIG. 1, at least two network nodes connected by a straight line are P2P radio communication apparatuses. Further, the communication system 100 forms redundant paths including an active path and a backup path by selecting/setting them from the paths 1, 2 and 3. An example in which the path 1 is the active path and the paths 2 and 3 are backup path candidates is described hereinafter. Note that although FIG. 1 shows a case where there are two backup path candidates, the number of backup path candidates may be three or more.

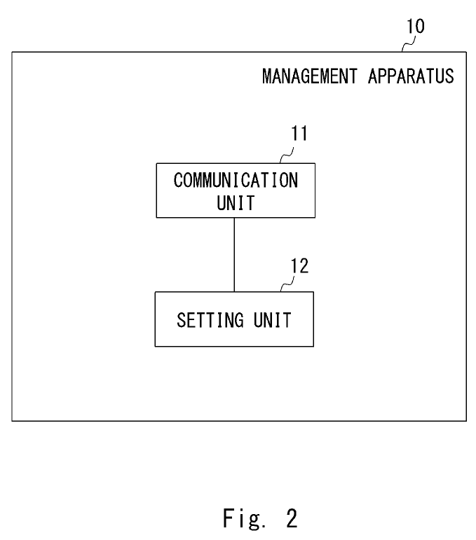

Next, a configuration example of the management apparatus 10 according to the first embodiment is described with reference to a block diagram shown in FIG. 2. The management apparatus 10 includes a communication unit 11 and a setting unit 12. The communication unit 11 and the setting unit 12 may be implemented by software, a module(s), or the like by which processes are performed by having a processor execute a program stored in a memory. Alternatively, the communication unit 11 and the setting unit 12 may be formed by hardware such as a circuit or a chip.

The communication unit 11 receives a first transmission delay time of an active path and a plurality of second transmission delay times of a plurality of backup path candidates. In the example shown in FIG. 1, the communication unit 11 receives a first transmission delay time of the path 1 and a second transmission delay time of each of the paths 2 and 3. Note that the communication unit 11 receives the first transmission delay time and the second transmission delay times from a node located at an end of the path. In the example shown in FIG. 1, the communication unit 11 receives the first transmission delay time and the second transmission delay times from at least one of the network nodes 20_1 and 20_2. Then, the communication unit 11 outputs the first transmission delay time and the second transmission delay times to the setting unit 12.

The setting unit 12 is a function unit that selects a backup path candidate from the plurality of backup path candidates based on differences between the plurality of second transmission delay times and the first transmission delay time, and sets the selected backup path candidate as the backup path. In the example shown in FIG. 1, the setting unit 12 obtains a difference between the received second transmission delay time of each of the paths 2 and 3 and the received first transmission delay time of the path 1. Further, the setting unit 12 selects a backup path candidate from the paths 2 and 3 based on the obtained differences. Further, the setting unit 12 sets the selected backup path candidate as the backup path.

Note that the setting unit 12 may reset the backup path at predetermined intervals. In this case, the communication unit 11 receives the first transmission delay time of the active path and the second transmission delay times of the plurality of backup path candidates including the backup path candidate set as the backup path at the predetermined intervals. Further, the setting unit 12 selects a backup path candidate from the plurality of backup path candidates based on differences between the plurality of second transmission delay times and the first transmission delay time at the predetermined intervals. Then, the setting unit 12 sets the selected backup path candidate as the backup path.

Note that the management apparatus 10 may further has a function of selecting a plurality of paths for which the management apparatus 10 instructs the network node 20 to measure transmission delay times, and instructing the network node 20 to measure transmission delay times of the plurality of selected paths through the communication unit 11. For example, the management apparatus 10 may select the paths 1 to 3 and instruct to measure transmission delay times of these paths at a timing at which a path is set to start a service between the network nodes 20_1 and 20_2. After that, the management apparatus 10 may instruct to measure transmission delay times at predetermined intervals. Note that the management apparatus 10 may have the above-described function in the setting unit 12 or may have the function in other function units such as a measurement path management unit 13.

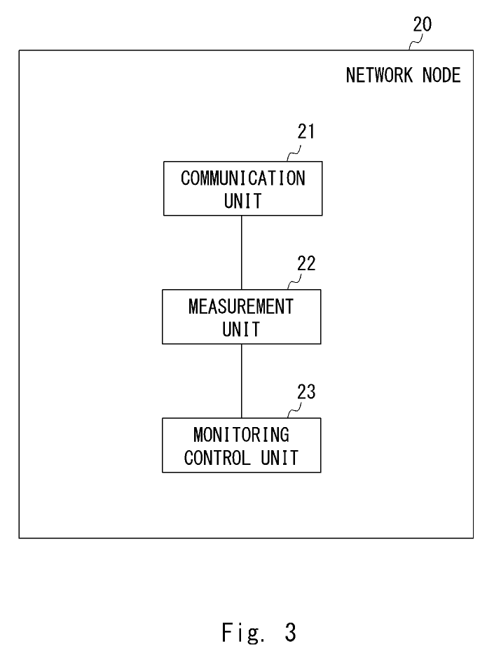

Next, a configuration example of the network node 20 according to the first embodiment is described with reference to a block diagram shown in FIG. 3. The network node 20 includes a communication unit 21, a measurement unit 22, and a monitoring control unit 23. The communication unit 21, the measurement unit 22, and the monitoring control unit 23 may be implemented by software, a module(s), or the like by which processes are performed by having a processor execute a program stored in a memory. Alternatively, the communication unit 21, the measurement unit 22, and the monitoring control unit 23 may be formed by hardware such as a circuit or a chip.

The communication unit 21 transmits/receives packets to/from other network nodes 20. Note that the communication unit 21 may be configured so that packets are transmitted/received through a wired communication path, or may be configured so that packets are transmitted/received through a wireless communication path.

The measuring unit 22 measures a first transmission delay time of an active path and a plurality of second transmission delay times of a plurality of backup path candidates by transmission/reception of packets performed by the communication unit 21. For example, the measurement unit 22 measures a transmission delay time of each path by using an OAM (Operations, Administration, Maintenance) function. Specifically, in the case where the network is a VLAN (Virtual Local Area Network), the measurement unit 22 measures a transmission delay time of each path by using Ethernet (Registered trademark) OAM. Further, in the case where the network is a network using MPLS (Multi Protocol Label Switching), the measurement unit 22 measures a transmission delay time of each path by using DM (Delay Measurement) of MPLS OAM. Note that the measurement of a transmission delay time performed by the measuring unit 22 is not limited to those performed based on the OAM function. Then, the measurement unit 22 outputs the first transmission delay time and the plurality of second transmission delay times to the monitoring control unit 23.

The monitoring control unit 23 transmits the received first transmission delay time and the plurality of plurality of the second transmission delay times to the management apparatus 10.

Note that the network node 20 may measure a transmission delay time of each path by using an instruction from the management apparatus 10 as a trigger. In this case, for example, the monitoring control unit 23 may receive a measurement instruction from the management apparatus 10.

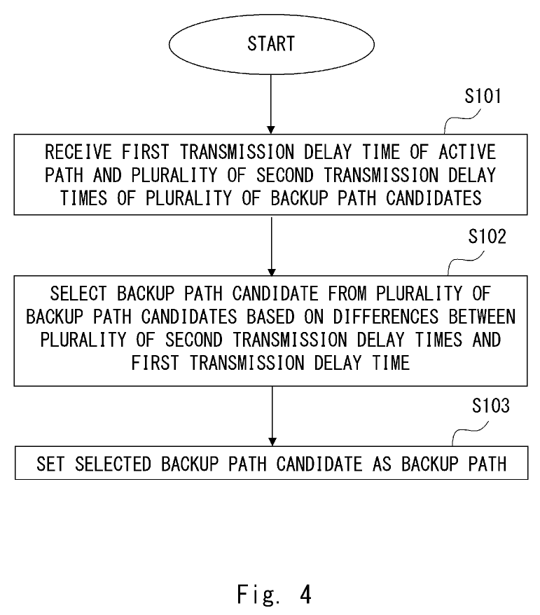

Next, an example of an operation performed by the management apparatus 10 is described with reference to a flowchart shown in FIG. 4.

Firstly, the management apparatus 10 receives a first transmission delay time of an active path and a plurality of second transmission delay times of a plurality of backup path candidates at a predetermined timing (step S101).

Next, the management apparatus 10 selects a backup path candidate from the plurality of backup path candidates based on differences between the plurality of second transmission delay times and the first transmission delay time (step S102).

Next, the management apparatus 10 sets the selected backup path candidate as the backup path (step S103).

As described above, in the communication system 100 according to the first embodiment of the present invention, the management apparatus 10 includes the communication unit 11 and the setting unit 12. Further, the setting unit 12 selects a backup path candidate from a plurality of backup path candidates based on differences between a plurality of second transmission delay times and a first transmission delay time, and sets the selected backup path candidate as a backup path. In this way, it is possible to set a backup path based on differences between transmission delay times of the plurality of backup path candidates and a transmission delay time of the active path. That is, it is possible to provide a management apparatus, a communication system, and a method therefor capable of avoiding a sudden change in a transmission delay time that would otherwise occur when a path is switched.

Further, the setting unit 12 may reset the backup path at predetermined intervals. In this way, even when a transmission delay time of each path is changed due to a change in traffic, an Adaptive Modulation function of a radio communication apparatus included in the network, or the like, it is possible to continuously avoid a sudden change in the transmission delay time that would otherwise occur when the path is switched.

### Second Embodiment

Next, a communication system 100A according to a second embodiment of the present invention is described. The communication system 100A according to the second embodiment is a specific example of the communication system 100 according to the first embodiment. Specifically, the communication system 100A is configured to use a management apparatus 10A in place of the management apparatus 10 of the communication system 100 shown in FIG. 1. Note that configurations of the communication system, the management apparatus, and the network nodes are similar to those shown in FIG. 1, FIG. 2, and FIG. 3, respectively. Therefore, their drawings are omitted.

Firstly, a configuration example of the management apparatus 10A according to the second embodiment is described. The management apparatus 10A includes a communication unit 11 and a setting unit 12A. Note that the communication unit 11 is similar to the communication unit 11 according to the first embodiment and hence the description thereof is omitted.

The setting unit 12A is a function unit that selects a backup path candidate for which a second transmission delay time has a smallest difference from the first transmission delay time among a plurality of second transmission delay times, and sets the selected backup path candidate as a backup path. In the example shown in FIG. 1, the setting unit 12A obtains a difference between the received second transmission delay time of each of the paths 2 and 3 and the received first transmission delay time of the path 1. Further, the setting unit 12A selects a backup path candidate for which the obtained difference is the smallest. Further, the setting unit 12A sets the selected backup path candidate as the backup path.

Further, the setting unit 12A may reset the backup path at predetermined intervals. In this case, the communication unit 11 receives the first transmission delay time of the active path and the plurality of second transmission delay times of the plurality of backup path candidates including the backup path candidate set as the backup path at the predetermined intervals. Further, the setting unit 12A selects a backup path candidate for which a second transmission delay time has a smallest difference from the first transmission delay time among the plurality of second transmission delay times at the predetermined intervals. Then, the setting unit 12A sets the selected backup path candidate as the backup path.

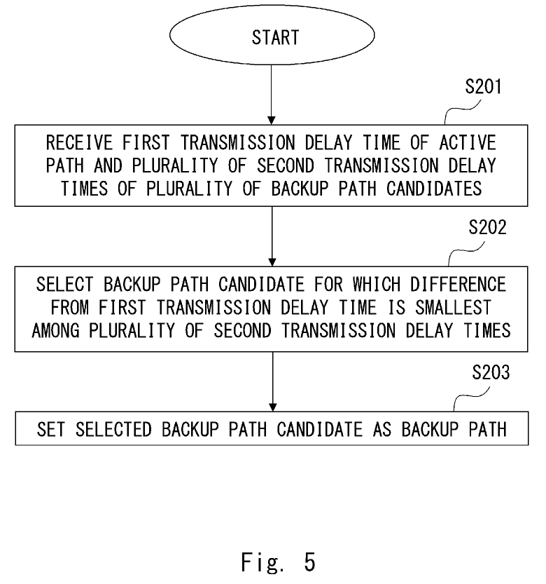

Next, an example of an operation performed by the management apparatus 10A is described with reference to FIG. 5.

Firstly, the management apparatus 10A receives a first transmission delay time of an active path and a plurality of second transmission delay times of a plurality of backup path candidates at a predetermined timing (step S201).

Next, the management apparatus 10A selects a backup path candidate for which a second transmission delay time has a smallest difference from the first transmission delay time among the plurality of second transmission delay times (step S202).

Next, the management apparatus 10A sets the selected backup path candidate as a backup path (step S203).

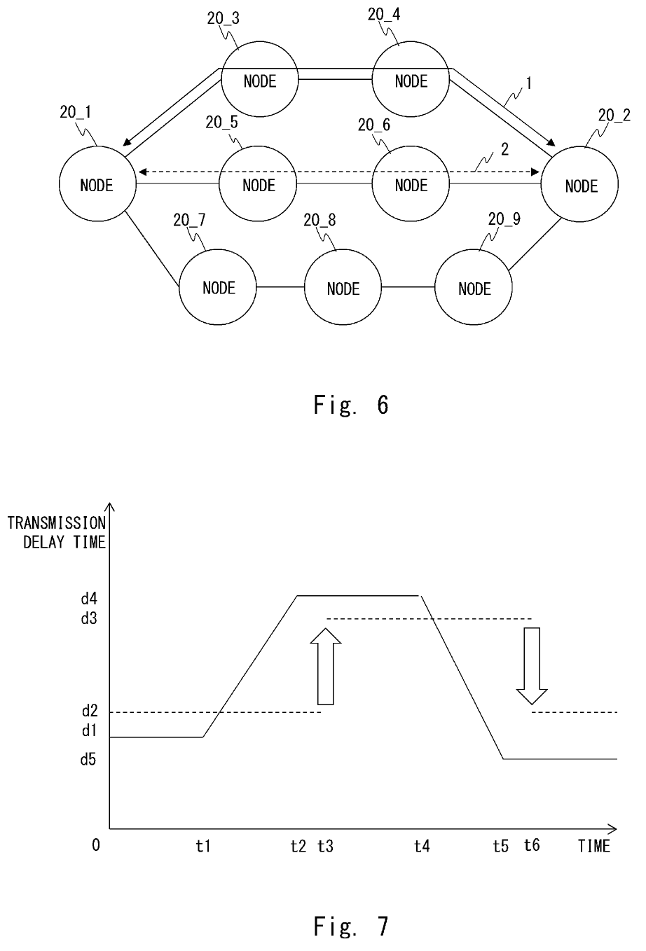

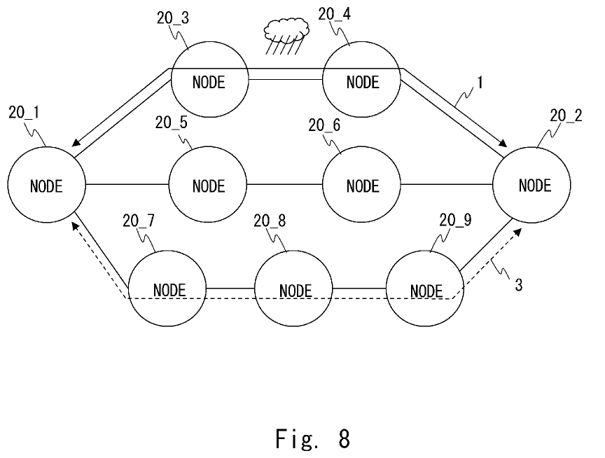

Next, an example of resetting of a backup path when a transmission delay time of an active path is changed due to a weather change is described with reference to FIGS. 6 to 8. Note that in FIGS. 6 and 8, active paths are indicated by straight-line arrows and backup paths are indicated by dotted-line arrows. Further, in FIGS. 6 and 8, it is assumed that network nodes 20_3 and 20_4 are P2P radio communication apparatuses and P2P radio communication is performed between these nodes.

FIG. 6 shows a state where a path 1 is set as an active path and a path 2 is set as a backup path. Note that in FIG. 6, a transmission delay time of the path 1 is represented by d1 and a transmission delay time of the path 2 is represented by d2. Further, a transmission delay time of a path 3 is represented by d3. Further, it is assumed that a difference between the transmission delay times d1 and d2 is smaller than a difference between the transmission delay times d1 and d3.

FIG. 7 is a graph showing a relation between transitions of a transmission delay time of an active path and resetting of a backup path. In FIG. 7, the transmission delay time of the active path is indicated by a solid line and the transmission delay time of the backup path is indicated by a dotted line. Note that a path setting in an initial state (i.e., a state at a time 0) in FIG. 7 is in the state shown in FIG. 6.

In FIG. 7, the transmission delay time of the path 1, which is the active path, has a value d1 in a period from the time 0 to t1. Therefore, the path 2 for which a transmission delay time has a smallest difference from the transmission delay time of the path 1 is set as a backup path.

In a period from the time t1 to t2, the weather changes from fine weather to bad weather and hence the state of the radio propagation path between the network nodes 20_3 and 20_4 deteriorates. At this point, because of the adaptive modulation, the network nodes 20_3 and 20_4 change their modulation mode to one having a smaller modulation multilevel number. As a result, the transmission capacity between the network nodes 20_3 and 20_4 decreases. Further, the transmission delay time of the path 1 increases and reaches a value d4 at the time t2.

At a time t3, the setting unit 12A determines that a difference between the transmission delay time d4 of the path 1 and the transmission delay time d2 of the path 2 has become larger than a difference between the transmission delay time d4 of the path 1 and the transmission delay time d3 of the path 3. Therefore, the setting unit 12A selects the path 3 for which a transmission delay time has a smallest difference from the transmission delay time of the active path. Further, the setting unit 12A sets the selected path 3 as a new backup path. As a result, the path setting becomes one shown in FIG. 8.

In a period from a time t4 to t5, the weather changes from the bad weather to fine weather and hence the state of the radio propagation path between the network nodes 20_3 and 20_4 improves. At this point, because of the adaptive modulation, the network nodes 20_3 and 20_4 change their modulation mode to one having a larger modulation multilevel number. As a result, the transmission capacity between the network nodes 20_3 and 20_4 increases. Further, the transmission delay time of the path 1 decreases and reaches a value d5 at the time t5.

At a time t6, the setting unit 12A determines that a difference between the transmission delay time d5 of the path 1 and the transmission delay time d3 of the path 3 has become larger than a difference between the transmission delay time d5 of the path 1 and the transmission delay time d2 of the path 2. Therefore, the setting unit 12A selects the path 2 for which a transmission delay time has a smallest difference from the transmission delay time of the active path. Further, the setting unit 12A sets the selected path 2 as a new backup path. As a result, the path setting returns to one shown in FIG. 6.

Note that in FIGS. 6 to 8, a case where the transmission delay time of the active path is changed due to a weather change is described. However, the change in the transmission delay time is not limited such changes. For example, the backup path is also reset when the transmission delay time of the active path is changed due to congestion caused by an inflow of traffic or the like. Further, the backup path is also reset when the transmission delay time of the backup path, instead of the transmission delay time of the active path, is changed.

As described above, in the communication system 100A according to the second embodiment of the present invention, the management apparatus 10A includes the communication unit 11 and the setting unit 12A. Further, the setting unit 12A selects a backup path candidate for which a second transmission delay time has a smallest difference from the first transmission delay time among the plurality of second transmission delay times, and sets the selected backup path candidate as the backup path. In this way, it is possible to provide a management apparatus, a communication system, and a method therefor capable of avoiding a sudden change in a transmission delay time that would otherwise occur when a path is switched.

Further, the setting unit 12A may reset the backup path at predetermined intervals. In this way, even when a transmission delay time of each path is changed due to a change in traffic, an adaptive modulation function of a radio communication apparatus included in the network, or the like, it is possible to continuously avoid a sudden change in the transmission delay time that would otherwise occur when the path is switched.

### Third Embodiment

Next, a communication system 100B according to a third embodiment of the present invention is described. The communication system 100B according to the third embodiment is a specific example of the communication system 100 according to the first embodiment. Specifically, the communication system 100B is configured to use a management apparatus 10B in place of the management apparatus 10 of the communication system 100 shown in FIG. 1. Note that configurations of the communication system, the management apparatus, and the network nodes are similar to those shown in FIG. 1, FIG. 2, and FIG. 3, respectively. Therefore, their drawings are omitted.

Firstly, a configuration example of the management apparatus 10B according to the third embodiment is described. The management unit 10B includes a communication unit 11 and a setting section 12B. Note that the communication unit 11 is similar to the communication unit 11 according to the first embodiment and hence the description thereof is omitted.

The setting unit 12B is a function unit that selects a backup path candidate for which a second transmission delay time among the plurality of second transmission delay times has a difference from the first transmission delay time, the difference being within a predetermined range, and sets the selected backup path candidate as a backup path. In the example shown in FIG. 1, the setting unit 12B obtains a difference between the received second transmission delay time of each of the paths 2 and 3 and the received first transmission delay time of the path 1. Further, the setting unit 12B selects a backup path candidate for which the obtained difference is within the predetermined range. Further, the setting unit 12B sets the selected backup path candidate as a backup path. Note that the predetermined range used in this process is, for example, a value that is determined for each system. For example, when it is applied to an ACR service, values of the predetermined range may be determined based on a transmission delay fluctuation value which is caused when packets are removed by a filtering function.

Further, the setting unit 12B may reset the backup path at predetermined intervals. In this case, the communication unit 11 receives the first transmission delay time of the active path and the plurality of second transmission delay times of the plurality of backup path candidates including the backup path candidate set as the backup path at the predetermined intervals. Further, the setting unit 12B selects, at the predetermined intervals, a backup path candidate for which a second transmission delay time among the plurality of second transmission delay times has a difference from the first transmission delay time, the difference being within the predetermined range. Then, the setting unit 12B sets the selected backup path candidate as the backup path.

Further, when there are a plurality of backup path candidates for which second transmission delay times among the plurality of second transmission delay times have differences from the first transmission delay time, each difference being within the predetermined range, the setting unit 12B may select a backup path candidate from these backup path candidates according to a predetermined rule. Note that the predetermined rule is a rule that is determined for each system. For example, the setting unit 12B may select a backup path candidate having the smallest transmission delay time from among the plurality of backup path candidates for which second transmission delay times have differences from the first transmission delay time, each difference being within the predetermined range.

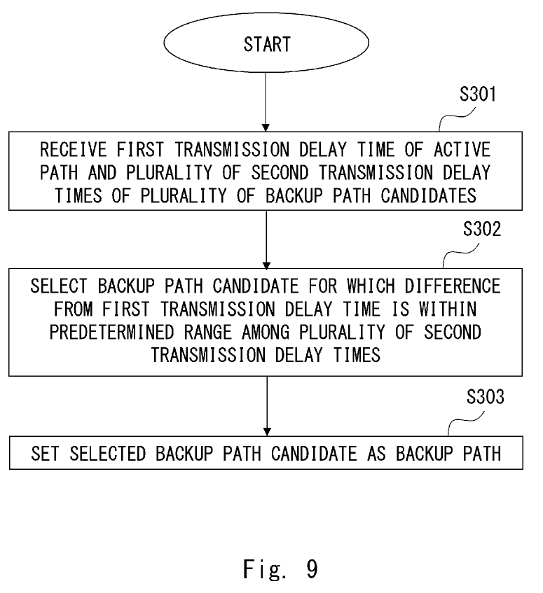

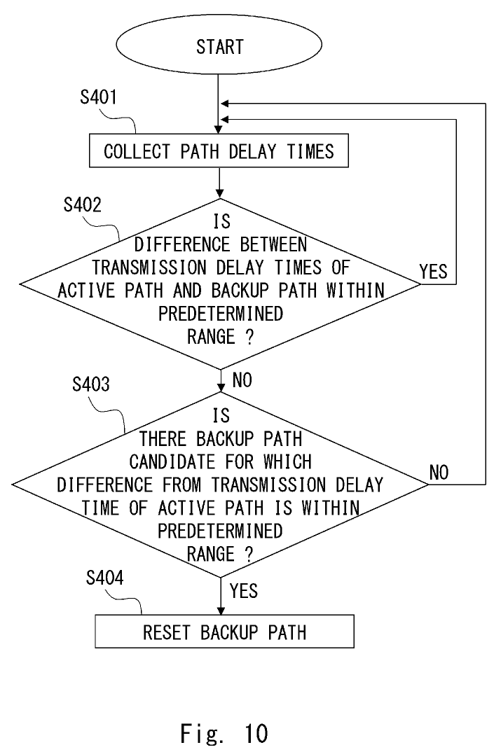

Next, an example of an operation performed by the management apparatus 10B is described with reference to FIG. 9.

Firstly, the management apparatus 10B receives a first transmission delay time of an active path and a plurality of second transmission delay times of a plurality of backup path candidates at a predetermined timing (step S301).

Next, the management apparatus 10B selects a backup path candidate for which a second transmission delay time among the plurality of second transmission delay times has a difference from the first transmission delay time, the difference being within the predetermined range (step S302).

Next, the management apparatus 10B sets the selected backup path candidate as a backup path (step S303).

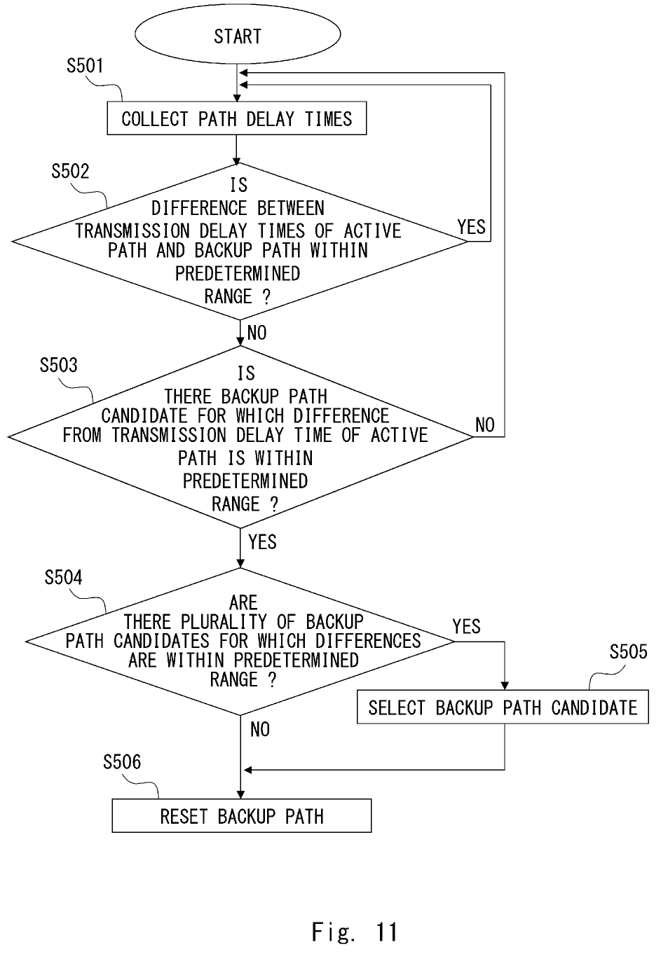

Next, an example of a backup-path resetting operation performed by the management apparatus 10B is described with reference to a flowchart shown in FIG. 10.

Firstly, the management apparatus 10B collects path delay information at a predetermined timing (step S401). In this process, the management apparatus 10B receives a transmission delay time of an active path, a transmission delay time of a backup path, and a transmission delay time(s) of a backup path candidate(s).

Next, the management apparatus 10B determines whether or not a difference between transmission delay times of the active path and the backup path is within a predetermined range (step S402).

When it is determined that the difference between transmission delay times of the active path and the backup path is within the predetermined range in the step S402 (Yes at step S402), the process returns to the step S401.

On the other hand, when it is determined that the difference between transmission delay times of the active path and the backup path is not within the predetermined range in the step S402 (No at step S402), the management apparatus 10B determines whether or not there is a backup path candidate for which a transmission delay time has a difference from the transmission delay time of the active path, the difference being within the predetermined range (step S403).

When it is determined that there is no backup path candidate for which a transmission delay time has a difference from the transmission delay time of the active path, the difference being within the predetermined range in the step S403 (No at step S403), the process returns to the step S401.

On the other hand, when it is determined that there is a backup path candidate for which a transmission delay time has a difference from the transmission delay time of the active path, the difference being within the predetermined range in the step S403 (Yes at step S403), the management apparatus 10B resets the backup path (step S404). That is, the management apparatus 10B sets the backup path candidate for which a transmission delay time has a difference from the transmission delay time of the active path, the difference being within the predetermined range as the backup path.

Next, another example of a backup-path resetting operation performed by the management apparatus 10B is described with reference to a flowchart shown in FIG. 11. Note that steps S501 to S503 in FIG. 11 are similar to the steps S401 to S403 in FIG. 10 and hence descriptions thereof are omitted.

When it is determined that there is a backup path candidate for which a transmission delay time has a difference from the transmission delay time of the active path, the difference being within the predetermined range in the step S503 (Yes at step S503), the management apparatus 10B determines whether or not there are a plurality of backup path candidates for which transmission delay times have differences from the transmission delay time of the active path, each difference being within the predetermined range (step S504).

When it is determined that there are a plurality of backup path candidates for which transmission delay times have differences from the transmission delay time, each difference being within the predetermined range in the step S504 (Yes at step S504), the management apparatus 10B selects a backup path candidate from these candidates (step S505). Note that the backup path candidate is selected according to a predetermined rule. Then, after the step S505, the management apparatus 10B resets the backup path (step S506). That is, the management apparatus 10B sets the backup path candidate selected in the step S505 as the backup path.

On the other hand, when it is determined that there are not a plurality of backup path candidates for which transmission delay times have differences from the transmission delay time, each difference being within the predetermined range in the step S504 (No at step S504), the management apparatus 10B resets the backup path (step S506). That is, the management apparatus 10B sets the backup path candidate for which a transmission delay time has a difference from the transmission delay time of the active path, the difference being within the predetermined range as the backup path.

As described above, in the communication system 100B according to the third embodiment of the present invention, the management apparatus 10B includes the communication unit 11 and the setting unit 12B. Further, the setting unit 12B selects a backup path candidate for which a second transmission delay time among the plurality of second transmission delay times has a difference from the first transmission delay time, the difference being within the predetermined range, and sets the selected backup path candidate as the backup path. In this way, it is possible to provide a management apparatus, a communication system, and a method therefor capable of avoiding a sudden change in a transmission delay time that would otherwise occur when a path is switched.

Further, the setting unit 12B may select a backup path candidate having the smallest transmission delay time from among the plurality of backup path candidates for which differences from the first transmission delay time are within the predetermined range. In this way, it is possible to avoid a sudden change in a transmission delay time that would otherwise occur when a path is switched and set a path having a small transmission delay time as a backup path.

Further, the setting unit 12B may reset the backup path at predetermined intervals. In this way, even when a transmission delay time of each path is changed due to a change in traffic, an adaptive modulation function of a radio communication apparatus included in the network, or the like, it is possible to continuously avoid a sudden change in the transmission delay time that would otherwise occur when the path is switched.

Further, the setting unit 12B may also select a path having the smallest transmission delay time from among a plurality of paths for which differences from the first transmission delay time are within the predetermined range at predetermined intervals. In this way, even when a transmission delay time of each path is changed due to a change in traffic, an adaptive modulation function of a radio communication apparatus included in the network, or the like, it is possible to continuously avoid a sudden change in the transmission delay time that would otherwise occur when the path is switched, and to always set a path having a small transmission delay time as a backup path.

Processes performed in each of the apparatuses described in the first to third embodiments (i.e., the management apparatus 10, the management apparatus 10A, management apparatus 10B, and the network node 20) can be carried out by using a computer system, such as an ASIC (Application Specific Integrated the Circuit), a DSP (Digital Signal Processor), an MPU (Micro Processing Unit), a CPU (Central Processing Unit), or a combination thereof, provided in the apparatus. Specifically, they may be carried out by having the computer system execute a program including a group of instructions related to a processing procedure of each apparatus described above with reference to a flowchart.

In the above-described examples, the program may be stored in various types of non-transitory computer readable media and thereby supplied to computers. The non-transitory computer readable media includes various types of tangible storage media. Examples of the non-transitory computer readable media include a magnetic recording medium (such as a flexible disk, a magnetic tape, and a hard disk drive), a magneto-optic recording medium (such as a magneto-optic disk), a CD-ROM (Read Only Memory), a CD-R, a CD-R/W, and a semiconductor memory (such as a mask ROM, a PROM (Programmable ROM), an EPROM (Erasable PROM), a flash ROM, and a RAM (Random Access Memory). These programs may be supplied to computers by using various types of transitory computer readable media. Examples of the transitory computer readable media include an electrical signal, an optical signal, and an electromagnetic wave. The transitory computer readable media can be used to supply programs to a computer through a wired communication line (e.g., electric wires and optical fibers) or a wireless communication line.

Note that the above-described first embodiment is explained on the assumption that the communication system 100 is a communication system configured to form redundant paths including an active path and a backup path while including a P2P radio communication apparatus in the redundant paths. However, the communication system 100 is not limited to such communication systems. The communication system 100 may be a communication system including a first path and a plurality of second paths. In this case, the communication unit 11 of the management apparatus 10 may receive a transmission delay time in a first path and transmission delay times in second paths. Further, the setting unit 12 of the management apparatus 10 may select a backup path for the first path from a plurality of second paths based on differences between transmission delay times in the second paths and a transmission delay time in the first path.

Similarly, the above-described communication system 100A according to the second embodiment may be a communication system including a first path and a plurality of second paths. In this case, the communication unit 11 of the management apparatus 10A may receive a transmission delay time in the first path and transmission delay times in the second paths. Further, the setting unit 12A of the management apparatus 10A may set a second path for which a second transmission delay time has a smallest difference from the transmission delay time in the first path among the transmission delay times in the second paths as a backup path for the first path.

Similarly, the above-described communication system 100B according to the third embodiment may be a communication system including a first path and a plurality of second paths. In this case, the communication unit 11 of the management apparatus 10B may receive a transmission delay time in the first path and transmission delay times in the second paths. Further, the setting unit 12B of the management apparatus 10B may set a second path for which a transmission delay time has a difference from the transmission delay time in the first path, the difference being within the predetermined range among the transmission delay times in the second paths as a backup path for the first path.

Although the present invention is described above with reference to embodiments, the present invention is not limited to the above-described embodiments. Various modifications that can be understood by those skilled in the art can be made to the configuration and details of the present invention within the scope of the invention.

For example, the whole or part of the embodiments disclosed above can be described as, but not limited to, the following supplementary notes.

### (Supplementary Note 1)

A management apparatus for a communication system configured to form redundant paths including an active path and a backup path while including a P2P (Point to Point) radio communication apparatus in the redundant paths, the management apparatus comprising:

a communication unit configured to receive a first transmission delay time of the active path and a plurality of second transmission delay times of a plurality of backup path candidates; and

a setting unit configured to select a backup path candidate from the plurality of backup path candidates based on differences between the plurality of second transmission delay times and the first transmission delay time, and set the selected backup path candidate as the backup path.

### (Supplementary Note 2)

The management apparatus described in Supplementary note 1, wherein the setting unit selects a backup path candidate for which a second transmission delay time has a smallest difference from the first transmission delay time among the plurality of second transmission delay times, and sets the selected backup path candidate as the backup path.

### (Supplementary Note 3)

The management apparatus described in Supplementary note 1, wherein the setting unit selects a backup path candidate for which a second transmission delay time among the plurality of second transmission delay times has a difference from the first transmission delay time, the difference being within the predetermined range, and sets the selected backup path candidate as the backup path.

### (Supplementary Note 4)

The management apparatus described in Supplementary note 3, wherein when there are a plurality of backup path candidates for which differences from the first transmission delay time are within the predetermined range, the setting unit selects a backup path candidate having a smallest transmission delay time from the plurality of backup path candidates for which differences from the first transmission delay time are within the predetermined range, and sets the selected backup path candidate as the backup path.

### (Supplementary Note 5)

The management apparatus described in any one of Supplementary notes 1 to 4, wherein the setting unit resets the backup path at a predetermined interval.

### (Supplementary Note 6)

A communication system configured to form redundant paths including an active path and a backup path while including a P2P (Point to Point) radio communication apparatus in the redundant paths, the communication system comprising:

a network node; and

a management apparatus, wherein

the network node comprises:

a communication unit configured to transmit/receive a packet to/from another network node;

a measurement unit configured to measure a first transmission delay time of the active path and a plurality of second transmission delay times of a plurality of backup path candidates by transmitting/receiving the packet; and

a monitoring control unit configured to transmit the first transmission delay time and the plurality of second transmission delay times to the management apparatus, and

the management apparatus comprises:

a communication unit configured to receive the first transmission delay time and the plurality of second transmission delay times; and

a setting unit configured to select a backup path candidate from the plurality of backup path candidates based on differences between the plurality of second transmission delay times and the first transmission delay time, and set the selected backup path candidate as the backup path.

### (Supplementary Note 7)

A method performed in a management apparatus for a communication system configured to form redundant paths including an active path and a backup path while including a P2P (Point to Point) radio communication apparatus in the redundant paths, the method comprising:

receiving a first transmission delay time of the active path and a plurality of second transmission delay times of a plurality of backup path candidates;

selecting a backup path candidate from the plurality of backup path candidates based on differences between the plurality of second transmission delay times and the first transmission delay time; and

setting the selected backup path candidate as the backup path.

### (Supplementary Note 8)

The method described in Supplementary note 7, wherein the selecting comprises selecting a backup path candidate for which a second transmission delay time has a smallest difference from the first transmission delay time among the plurality of second transmission delay times.

### (Supplementary Note 9)

The method described in Supplementary note 7, wherein the selecting comprises selecting a backup path candidate for which a second transmission delay time among the plurality of second transmission delay times has a difference from the first transmission delay time, the difference being within the predetermined range among the plurality of second transmission delay times.

### (Supplementary Note 10)

The method described in Supplementary note 9, wherein the selecting comprises selecting, when there are a plurality of backup path candidates for which differences from the first transmission delay time are within the predetermined range, a backup path candidate having a smallest transmission delay time from the plurality of backup path candidates for which differences from the first transmission delay time are within the predetermined range.

### (Supplementary Note 11)

The method described in any one of Supplementary notes 7 to 10, wherein the setting comprising resetting the backup path at a predetermined interval.

### (Supplementary Note 12)

A method performed in a communication system configured to form redundant paths including an active path and a backup path while including a P2P (Point to Point) radio communication apparatus in the redundant paths, wherein

the communication system comprises a network node, and a management apparatus,

the network node is configured to:

transmit/receive a packet to/from another network node;

measure a first transmission delay time of the active path and a plurality of second transmission delay times of a plurality of backup path candidates by transmitting/receiving the packet; and

transmit the first transmission delay time and the plurality of second transmission delay times to the management apparatus, and

the management apparatus is configured to;

receive the first transmission delay time and the plurality of second transmission delay times;

select a backup path candidate from the plurality of backup path candidates based on differences between the plurality of second transmission delay times and the first transmission delay time; and

set the selected backup path candidate as the backup path.

### (Supplementary Note 13)

A management apparatus for a communication system including a first path and a plurality of second paths, the management apparatus comprising:

a communication unit configured to receive a transmission delay time in the first path and transmission delay times in the second paths; and

a setting unit configured to select a backup path for the first path from the plurality of second paths based on differences between the transmission delay times in the second paths and the transmission delay time in the first path.

This application is based upon and claims the benefit of priority from Japanese patent application No. 2016-139306, filed on Jul. 14, 2016, the disclosure of which is incorporated herein in its entirety by reference.

### REFERENCE SIGNS LIST

10, 10A, 10B MANAGEMENT APPARATUS
11 COMMUNICATION UNIT
12, 12A, 12B SETTING UNIT
20 NETWORK NODE
21 COMMUNICATION UNIT
22 MEASUREMENT UNIT
23 MONITORING CONTROL UNIT
100, 100A, 100B COMMUNICATION SYSTEM

1. A management apparatus for a communication system configured to form redundant paths including an active path and a backup path while including a P2P (Point to Point) radio communication apparatus in the redundant paths, the management apparatus comprising:
a communication unit configured to receive a first transmission delay time of the active path and a plurality of second transmission delay times of a plurality of backup path candidates; and
a setting unit configured to select a backup path candidate from the plurality of backup path candidates based on differences between the plurality of second transmission delay times and the first transmission delay time, and set the selected backup path candidate as the backup path.

2. The management apparatus according to claim 1, wherein the setting unit selects a backup path candidate for which a second transmission delay time has a smallest difference from the first transmission delay time among the plurality of second transmission delay times, and sets the selected backup path candidate as the backup path.

3. The management apparatus according to claim 1, wherein the setting unit selects a backup path candidate for which a second transmission delay time among the plurality of second transmission delay times has a difference from the first transmission delay time, the difference being within the predetermined range, and sets the selected backup path candidate as the backup path.

4. The management apparatus according to claim 3, wherein when there are a plurality of backup path candidates for which differences from the first transmission delay time are within the predetermined range, the setting unit selects a backup path candidate having a smallest transmission delay time from the plurality of backup path candidates for which differences from the first transmission delay time are within the predetermined range, and sets the selected backup path candidate as the backup path.

5. The management apparatus according to claim 1, wherein the setting unit resets the backup path at a predetermined interval.

6. A communication system configured to form redundant paths including an active path and a backup path while including a P2P (Point to Point) radio communication apparatus in the redundant paths, the communication system comprising:
a network node; and
a management apparatus, wherein
the network node comprises:
a communication unit configured to transmit/receive a packet to/from another network node;
a measurement unit configured to measure a first transmission delay time of the active path and a plurality of second transmission delay times of a plurality of backup path candidates by transmitting/receiving the packet; and
a monitoring control unit configured to transmit the first transmission delay time and the plurality of second transmission delay times to the management apparatus, and
the management apparatus comprises:
a communication unit configured to receive the first transmission delay time and the plurality of second transmission delay times; and
a setting unit configured to select a backup path candidate from the plurality of backup path candidates based on differences between the plurality of second transmission delay times and the first transmission delay time, and set the selected backup path candidate as the backup path.

7. A method performed in a management apparatus for a communication system configured to form redundant paths including an active path and a backup path while including a P2P (Point to Point) radio communication apparatus in the redundant paths, the method comprising:
receiving a first transmission delay time of the active path and a plurality of second transmission delay times of a plurality of backup path candidates;
selecting a backup path candidate from the plurality of backup path candidates based on differences between the plurality of second transmission delay times and the first transmission delay time; and
setting the selected backup path candidate as the backup path.

8. The method according to claim 7, wherein the selecting comprises selecting a backup path candidate for which a second transmission delay time has a smallest difference from the first transmission delay time among the plurality of second transmission delay times.

9. The method according to claim 7, wherein the selecting comprises selecting a backup path candidate for which a second transmission delay time among the plurality of second transmission delay times has a difference from the first transmission delay time, the difference being within the predetermined range.

10. The method according to claim 9, wherein the selecting comprises selecting, when there are a plurality of backup path candidates for which differences from the first transmission delay time are within the predetermined range, a backup path candidate having a smallest transmission delay time from the plurality of backup path candidates for which differences from the first transmission delay time are within the predetermined range.

11. The method according to claim 7, wherein the setting comprising resetting the backup path at a predetermined interval.

12. (canceled)

13. A management apparatus for a communication system including a first path and a plurality of second paths, the management apparatus comprising:
a communication unit configured to receive a transmission delay time in the first path and transmission delay times in the second paths; and
a setting unit configured to select a backup path for the first path from the plurality of second paths based on differences between the transmission delay times in the second paths and the transmission delay time in the first path.
